(19) United States
(12) Patent Application Publication
(10) Pub. No.: US 2011/0005301 A1
(43) Pub. Date: Jan. 13, 2011

(54) Perspiration Simulator

(75) Inventor: Jeremy Miles Gibson-Harris, Buckingham (GB)

Correspondence Address: GROSSMAN, TUCKER, PERREAULT & PFLEGER, PLLC, 55 SOUTH COMMERICAL STREET, MANCHESTER, NH, 03101, US

(73) Assignee: CRAWLEY CREATURES LIMITED, Aylesbury, Buckinghamshire (GB)

(21) Appl. No.: 12/867,196

(22) PCT Filed: Feb. 12, 2009
(86) PCT No.: PCT/GB2009/050138

§ 371 Date: Aug. 11, 2010

(30) Foreign Application Priority Data
Feb. 12, 2008 (GB) 0802517.3

(51) Int. Cl. G01N 19/10

(52) U.S. Cl. 73/29.02

(57) ABSTRACT

The present invention provides an apparatus and method for simulating the thermal and perspiratory properties of human skin. The present invention provides an apparatus capable of being formed into any anthropometric form to emulate the thermal and perspiratory properties of an equivalent human part. The apparatus generally comprises thermally controlled, contoured, skeletal structure, typically made of metal, which can be split into any number of individually heated zones. The skeletal structure is covered with a correspondingly contoured soft synthetic polymer skin, incorporating any number of sweat zones, which is adhered to the skeletal structure. Each sweat zone is comprised of a reservoir of artificial perspiration embedded into the reverse of the skin punctured with wicking threads leading to the surface of the skin. Each sweating zone is individually dosed using a controllable pump, and a network of valves direct the sweat flow.

### FIELD OF THE INVENTION

The present invention relates to apparatus for simulating perspiration and/or respiration by a human form. It is particularly applicable, but in no way limited to apparatus for simulating perspiration from a human head form or other parts of the human or animal anatomy, and more particularly to methods and apparatus for simulating perspiration and respiration by a human head form for use in testing protective head wear, such as protective goggles and respirators, for fogging and misting from perspiration and respiration.

### BACKGROUND OF THE INVENTION

Early systems for attempting to simulate perspiration by a human form, and in particular by a human head form, involved creating a human head form which was capable of being heated. The simulation of perspiration was created by putting a wet cloth in contact with the head form. Where the head form is being used to test protective goggles of respirators, the wet cloth is typically placed across the eyes of the head form underneath the protective goggles or respirator. The head form also comprised a camera placed in one eye. The head form was then heated, which resulted in water from the wet cloth forming vapour to simulate perspiration, the amount of fogging or misting within the goggles or respirator was then calculated from the fogging or misting of the camera.

Such systems have a number of limitations which include the inability to create perspiration in predefined areas at predefined rates in order to access the results. The head forms were formed from a rigid material which was quite dissimilar to human skin and therefore did not behave as such. Thus the protective goggles or respirators being tested usually could not sit, fit and seal on the head form in the same way as the protective goggles or respirators would sit, fit and seal on a real human head.

### SUMMARY OF THE INVENTION

According to an aspect of the present invention there is provided an apparatus for simulating perspiration comprising:
a) an anthropometric form adapted to simulate at least part of a human or animal body;
b) a plurality of artificial perspiration zones located on the anthropometric; and
c) detection means.

This is particularly advantageous as it allows for apparatus to more realistically simulate perspiration from a plurality of perspiration zones. Preferably there are 2 or more perspiration zones, more preferably there are 10 or more perspiration zones, still more preferably there are 20 or more perspiration zones, yet more preferably there are 30 or more perspiration zones, most preferably there are 40 or more perspiration zones.

Preferably the apparatus is capable of simulating respiration of a human or animal. This is particularly advantageous as is allows for more realistic simulation of a human or animal form for testing of levels of perspiration without needing to subject a real human or animal to the testing regime.

Preferably each of the artificial perspiration zones comprises an artificial perspiration reservoir for containing artificial perspiration, and means for facilitating release of the artificial perspiration from the perspiration reservoirs. This is advantageous as it allows for the artificial perspiration to be stored close to the surface of the artificial perspiration zones for a controlled repeatable release of the artificial perspiration during testing.

Preferably each of the artificial perspiration reservoirs comprises a hydrophilic membrane. This is advantageous as a hydrophilic membrane will more readily hold and store the hydrophilic artificial perspiration, which preferably is water or distilled water. In the alternative the artificial perspiration may be a fluid designed to replicate human or animal perspiration by the addition of salts and the like.

Preferably the means for facilitating release of the artificial perspiration from the artificial perspiration reservoir comprises a wick extending from the artificial perspiration reservoir to the atmosphere. This is advantageous as it allows for a controlled repeatable release of the artificial perspiration from the reservoir stores to the surface for evaporation of the artificial perspiration.

Preferably the wick is separate to the artificial perspiration reservoir

Preferably the wick is integral with the artificial perspiration reservoir

Preferably the apparatus further comprises a synthetic skin adapted to cover all of part of the anthropometric form. This is particularly advantageous as the synthetic skin simulates real skin and allows for the apparatus being tested to seal in the same way as it would seal on real skin so that the apparatus can be efficiently tested.

Preferably the artificial perspiration reservoirs are located between the anthropometric form and the synthetic skin and the wicks extend from the artificial perspiration reservoirs through the synthetic skin to the external surface of the synthetic skin.

Preferably the artificial perspiration reservoirs are located on the external surface of the synthetic skin.

Preferably the apparatus further comprises means for introducing artificial perspiration to the artificial perspiration reservoirs.

Preferably the means for introducing artificial perspiration to the artificial perspiration reservoirs comprises a series of individually computer-controlled valves. This is advantageous as the reservoirs can be loaded with a pre-selected amount of artificial perspiration for the simulation.

Preferably the anthropometric form is heat conductive.

Preferably the anthropometric form is divided into one or more independently controlled heated areas. This is advantageous as it more realistically simulates how different areas of a human or animal body heat up to different temperatures and at different rates.

Preferably when the apparatus is heated this results in artificial perspiration being released from the artificial perspiration reservoirs.

Preferably the anthropometric form is adapted to simulate the head of a human.

Preferably the apparatus further comprises at least one eye socket.

Preferably the detection means is located in the at least one eye socket.

Preferably the detection means comprises a camera.

Preferably the detection means comprises a vision acquisition system.

Preferably the detection means comprises an NI (National Instruments) vision system.

Preferably the detection means comprises a temperature sensor.

Preferably the detection means comprises a humidity sensor.

Preferably the detection means comprises a moisture sensor.

Preferably the apparatus further comprises a mouth cavity.

Preferably the mouth cavity is provided with a breathing tube to simulate respiration. This is particularly advantageous as in a full respirator rather than goggles water in the breath of the human or animal will also contribute to any fogging or misting of the respirator as well as the perspiration to give a more realistic simulation.

Preferably the breathing tube is connected to a humidifier. This is advantageous as it allows the artificial breath to be humidified to more realistically simulate real human or animal breath.

Preferably the apparatus further comprises a climatic chamber in which the anthropometric form is located within.

Preferably the climatic chamber provides for external control of temperature and humidity. This is advantageous as it allows the tester to determine if the external climate is different from the internal climate of the goggles or respirator or other apparatus being tested whether this would have an effect on the misting or fogging of the apparatus being tested.

Preferably the anthropometric form is provided with goggles or a respirator or other protective head wear.

Preferably the level of misting or fogging inside the goggles or respirator or other protective head wear resulting from the artificial perspiration or respiration is measured by the detection means.

According to a further aspect of the present invention there is provided an apparatus for simulating perspiration and respiration comprising:
a) an anthropometric form adapted to simulate at least the head of a human or animal body wherein the anthropometric form is provided with:
   i) a mouth cavity connected to a breathing tube adapted to simulate respiration; and
   ii) a plurality of artificial perspiration zones adapted to simulate perspiration; and
b) a detection means.

According to another aspect of the present invention there is provided a method of simulating perspiration comprising the steps of
a) providing an apparatus for simulating perspiration comprising;
   i) an anthropometric form adapted to simulate at least part of a human or animal body;
   ii) a plurality of artificial perspiration zones located on the anthropometric; and
   iii) detection means.
b) causing the artificial perspiration zones to perspire artificially; and
c) measuring the perspiration created using the detection means

Preferably the method is capable of simulating respiration of a human or animal.

Preferably each of the artificial perspiration zones comprises an artificial perspiration reservoir for containing artificial perspiration, and means for facilitating release of the artificial perspiration from the perspiration reservoirs.

Preferably each of the artificial perspiration reservoirs comprises a hydrophilic membrane.

Preferably the means for facilitating release of the artificial perspiration from the artificial perspiration reservoir comprises a wick extending from the artificial perspiration reservoir to the atmosphere.

Preferably the wick is separate to the artificial perspiration reservoir

Preferably the wick is integral with the artificial perspiration reservoir

Preferably the method further comprises providing a synthetic skin adapted to cover all of part of the anthropometric form.

Preferably the artificial perspiration reservoirs are located between the anthropometric form and the synthetic skin and the wicks extend from the artificial perspiration reservoirs through the synthetic skin to the external surface of the synthetic skin.

Preferably the artificial perspiration reservoirs are located on the external surface of the synthetic skin.

Preferably the method further comprises providing means for introducing artificial perspiration to the artificial perspiration reservoirs.

Preferably the means for introducing artificial perspiration to the artificial perspiration reservoirs comprises a series of individually computer-controlled valves.

Preferably the anthropometric form is heat conductive.

Preferably the anthropometric form is divided into one or more independently controlled heated areas.

Preferably the method provides that when the apparatus is heated it results in artificial perspiration being released from the artificial perspiration reservoirs.

Preferably the anthropometric form is adapted to simulate the head of a human.

Preferably the method further comprises providing at least one eye socket.

Preferably the detection means is located in the at least one eye socket.

Preferably the detection means comprises a camera.

Preferably the detection means comprises a vision acquisition system.

Preferably the detection means comprises an NI vision system.

In an alternative embodiment the detection means in addition or in the alternative comprises a temperature sensor

In an alternative embodiment the detection means in addition or in the alternative comprises a humidity sensor

In an alternative embodiment the detection means in addition or in the alternative comprises a moisture sensor

Preferably the method further comprises providing a mouth cavity.

Preferably the mouth cavity is provided with a breathing tube to simulate respiration.

Preferably the breathing tube is connected to a humidifier.

Preferably the method further comprises providing a climatic chamber in which the anthropometric form is located within.

Preferably the climatic chamber provides for external control of temperature and humidity.

Preferably the anthropometric form is provided with goggles or a respirator or other protective head wear.

Preferably the level of misting or fogging inside the goggles or respirator or other protective head wear resulting from the artificial perspiration or respiration is measured by the detection means.

According to a further aspect of the present invention there is provided a method of testing the effect of human or animal perspiration on articles covering the whole or part of a human or animal anthropometric form comprising the steps of:
a) releasing artificial perspiration from a plurality of artificial perspiration zones located on the anthropometric form;
b) using a detection means to collect data relating to the level of artificial perspiration on at least part of the article.

Preferably the detection means is a camera, alternatively or in addition the detection means is a temperature sensor, or a humidity sensor or a moisture sensor.

Preferably the data collected is an image of a test chart screen.

Preferably the test chart screen is a series of shapes on a background. More preferably the test chart screen is a series of dark shapes on a light background. Most preferably the test chart screen is a series of black shapes on a white background.

Preferably the method further comprises sending the data collected by the detection means to a control system.

Preferably the control system determines the area of the shapes which are visible in the image.

Preferably the control system determines the contrast of the shapes which are visible in the image.

Preferably the control system compares the area of the shapes during or after the simulation with the calibrated area of the shapes before the simulation.

Preferably the control system compares the contrast of the shapes during or after the simulation with the calibrated contrast of the shapes before the simulation.

Preferably the control system compares the comparison of the area of the shapes during or after the simulation with the calibrated area of the shapes before the simulation with calibrated acuity filter data of vision levels.

Preferably the control system compares the comparison of the contrast of the shapes during or after the simulation with the calibrated area of the shapes before the simulation with calibrated acuity filter data of vision levels.

Preferably the control system generates a result of the equivalent vision level resultant from the artificial perspiration.

Preferably the data is the temperature caused by the artificial perspiration.

Preferably the data is the level of humidity caused by the artificial perspiration.

Preferably the data is the level of moisture caused by the artificial perspiration.

The present invention provides an apparatus and method for simulating the thermal and perspiratory properties of human skin. The present invention provides an apparatus capable of being formed into any anthropometric form to emulate the thermal and perspiratory properties of an equivalent human part. The apparatus generally comprises thermally controlled, contoured, skeletal structure, typically made of metal, which can be split into any number of individually heated zones. The skeletal structure is covered with a correspondingly contoured soft synthetic polymer skin, incorporating any number of sweat zones, which is adhered to the skeletal structure. Each sweat zone is comprised of a reservoir of artificial perspiration embedded into the reverse of the skin punctured with wicking threads leading to the surface of the skin. Dosing needles are inserted into the reservoirs through holes in the skeletal structure and clamped into place. Each sweating zone is individually dosed using a controllable pump, and a network of valves to direct the sweat flow.

In one embodiment of the present invention there is specifically provided an apparatus and method for testing and evaluating the formation and propagation of mist in respirators, goggles and the like through realistic simulation of the thermal and perspiratory properties of the human head. A computer controlled apparatus is provided for simulating the thermal and perspiratory properties of a human head form to evaluate the formation and propagation of mist in respirators, goggles and other headwear. The apparatus comprises a head form covered with a soft synthetic skin, exhibiting a multi-zone individually dosed sweating system split into a number of individually controlled heating sections, a corresponding sweating and heating control systems, a humidifying breathing machine and a climatic chamber. Software is used to control and monitor the hardware elements of the system. Feedback from one or more preferably internally mounted detection means. The detection means may be a camera, a vision acquisition system, temperatures sensors, humidity sensors, moisture sensors or the like. The feedback from the detection means is processed by software, providing the user with detailed real-time misting information. A detailed report of each test sequence is produced on completion, describing periodically for example sampled sensor feedback and analysed vision images.

The Perspiration Simulator has been designed as a test-bed for evaluating the formation and propagation of mist in respirators, goggles and other headwear. It has been developed to provide improved test data accuracy and repeatability. Exhibiting a large range of user-defined variables allows the simulator to meet numerous test conditions, permitting simulations of many different scenarios and environments for comprehensive analysis. In alternative embodiments the apparatus in alternative form may be used for testing other safety equipment which is affected by perspiration from other parts of the human form, in these embodiments the head form is replaced by another anthropometric as required to be tested.

### BRIEF DESCRIPTION OF THE DRAWINGS

The present invention will now be described by way of example only with reference to the accompanying drawings, wherein:

FIG. 1 is a schematic chart of the apparatus of an embodiment of the present invention.

FIG. 2 is a front view of a head form without synthetic skin according to an embodiment of the present invention.

FIG. 3 is a front view of a head form with synthetic skin according to an embodiment of the present invention.

FIG. 4 is a view of a head form and rear of the synthetic skin according to an embodiment of the present invention.

FIG. 5 is an exploded view of the perspiration zone and wicking system according to an embodiment of the present invention.

FIG. 6 is a cross-section view of the perspiration zone and wicking system according to an embodiment of the present invention.

FIG. 7 is a cross-section view of a head form with detection means, breathing tube and respirator according to an embodiment of the present invention.

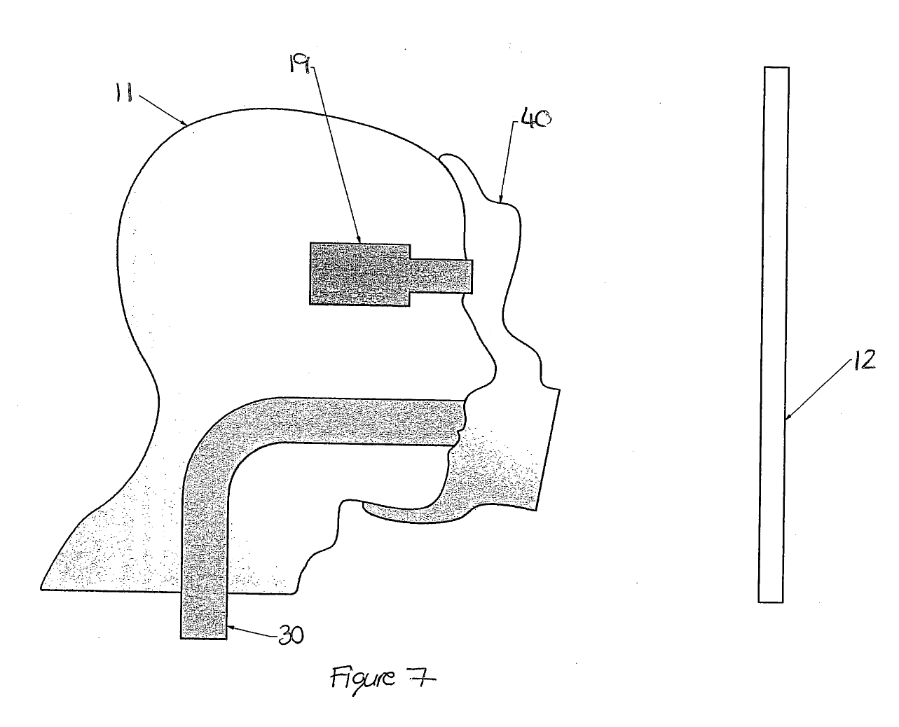

### DESCRIPTION OF THE PREFERRED EMBODIMENTS

The present embodiments represent the best ways currently known to the applicant of putting the invention into practice. However, they are not the only ways in which this can be achieved. They are illustrated, and will now be described, by way of example only.

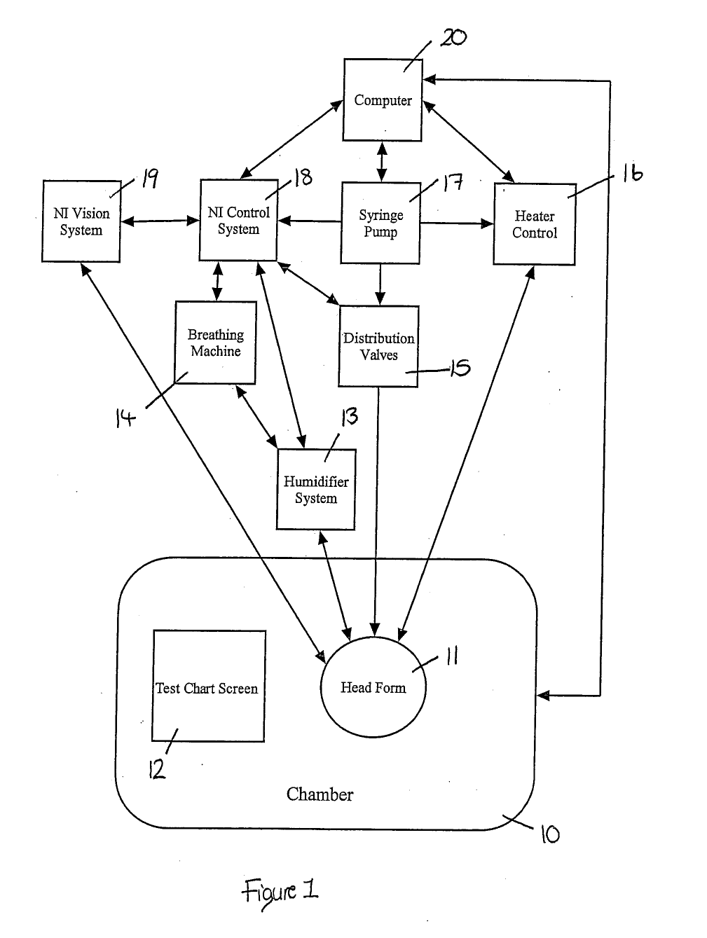

Referring to FIG. 1, which shows a full schematic diagram of the individual components which can be included in the Perspiration and Respiration Simulator, the Perspiration and Respiration Simulator comprises six main elements; the head form 11, chamber 10, syringe pump 17, heat control 16, breathing machine 14 and humidifier system 13. Each of these elements is controlled and monitored via a user interface on a computer 20; the user interface enables the user to configure the perspiration simulator using a control system called the Head Form Control Program. The present invention comprises a chamber 10. In one embodiment of the present invention is a climatic chamber capable of having its internal temperature and humidity controlled to create a desired climate within the chamber 10. The chamber 10 is in an embodiment rated from −75° C. to +180° C. with relative humidity control between 10 and 98%.

Located inside the chamber 10 is a head form 11 and a test chart screen 12. In the embodiment shown in the figures the head form 11 is an anthropometric human head form, however in an alternative embodiment the head form 11 may be replaced by a full anthropometric human form, or an alternative individual human body part such as a torso or limb, or by a full anthropometric animal form or part of an animal form depending upon the perspiration and respiration to be simulated and tested.

The head form 11 is designed such that standard goggles, respirators and the like can be placed on the head form 11 as worn by humans. The user interface Head Form Control Program can then be run on the computer 20 to simulate the head form 11 in various situations and environments. In order to record the results of the simulations the head form 11 is provided with a detection means. In one embodiment the detection means is a NI (National Instruments) vision system 19. In an alternative embodiment the detection means is a vision acquisition system. In a further alternative embodiment the detection means is a camera. In another embodiment the detection means may be a humidity sensor or a temperature sensor or a moisture sensor. The NI vision system 19 is in one embodiment located in one of the eye sockets 21, 22 provided for in the head form 11. In an alternative embodiment the NI vision system 19 is located in both of the eye sockets 21, 22 provided for in the head form 11.

The NI vision system 19 in the head form 11 will be trained on the test chart screen 12, with results taken pre-simulation and during the simulation and post-simulation. The amount of fogging and misting can then be determined by comparing the pre-simulation and post-simulation NI vision system results. The computer 20 has inbuilt algorithms in the control system of the user interface to determine the level of fogging and misting and compare this to standardised acuity levels of visual impairment. The test chart screen 12 in one embodiment comprises a grid of black squares spaced with clear gaps between. The chart has been designed in this fashion to provide a high resolution of zones over the largest area possible. The uniform square test chart screen 12 was chosen, as it only requires one iteration of vision processing per frame although, through software analysis, four different intensity levels of mist can be discerned to an acceptable tolerance. This test chart screen 12 design also significantly reduces effects of unacknowledged localized misting that can occur in a chart comprised of single grayscale target objects.

The various elements of the Perspiration Simulator connected to the computer 20. The computer is then programmed to run various simulations by controlling the heat levels, perspiration levels, climatic levels and respiration levels to simulate a human head in desired situations and environments.

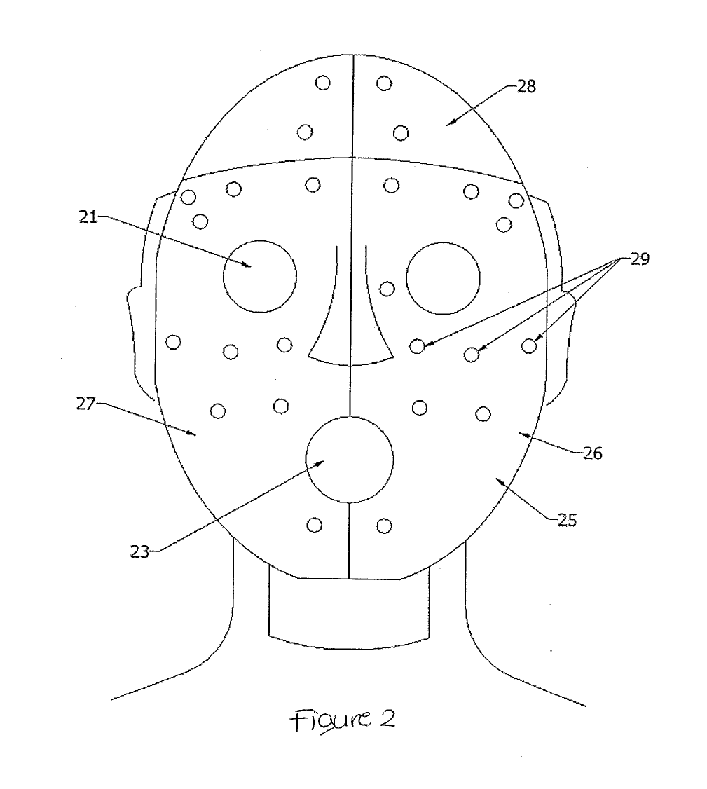

The anthropometric head form 11 has been designed to emulate a human head and torso as realistically as possible with current mechanical and electronic systems and components. The internal anthropometric skeletal form can be more clearly see in FIG. 2. The head form 11 is formed from a front portion or face 25 formed from a thermally conductive material. In one embodiment of the thermally conductive material is a metal such as copper. In alternative embodiment the thermally conductive material is a plastics material. In a further alternative embodiment the thermally conductive material is a carbon composite material. The face 25 is provided with eye sockets 21, 22 in which a NI vision system 19 can be mounted and a mouth cavity 23 in which a breathing tube 30 can be mounted. The face 25 is split into two sections 26, 27, which are capable of being heated independently from each other. The face 25 is provided with a plurality of perspiration zones 29 which in the face 25 are apertures which lead through inside the head form. Each of the apertures of the perspiration zones 29 are connected to distribution valves 15 which are in turn connected to a syringe pump 17. In alternative embodiment of the present invention alternative pumps to a syringe pump may be employed. It is through these apertures that artificial perspiration is released from the head form 11. The head form 11 is also formed from a top portion 28 which is also provided with perspiration zones. The perspiration zones 29 in the head form 11 have been strategically placed to mimic the main perspiration zones found in the human head. The back of the head form 11 completing the head form is formed from a material which is not as thermally conductive as the face 25. In one embodiment the back of the head form is formed of a plastics material. In an alternative embodiment the back of the head form is formed of a carbon composite material. This part of the head form is devoid of perspiration zones in the present embodiment as the present embodiment is designed for testing fogging or misting in goggles, respirators and the like. In this embodiment perspiration zones are not needed in the back of the head form 11. However in an alternative embodiment, when testing full head apparatus such as hazmat suits it may be necessary to construct the rear of the head form 11 from a thermally conductive material the same as the face 25, so that it too can be heated as desired and provided with perspiration zones as required. In the embodiment shown, the back of the head form 11 is provided with a hatch to enable the user to access the internal distribution valves 15 as required for maintenance and the like. In an embodiment the perspiration zones 29 and apertures in the head form 11 are provided directly with injection pins 31 to allow for easy addition of artificial perspiration as directed by the particular program and test being run at any time.

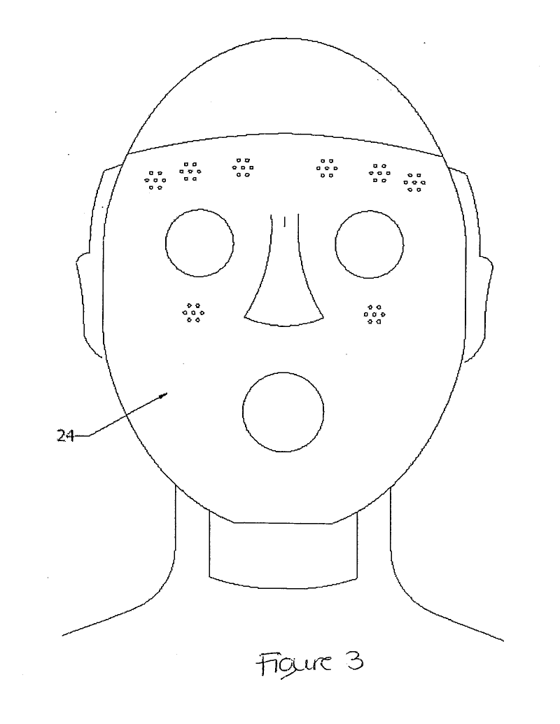

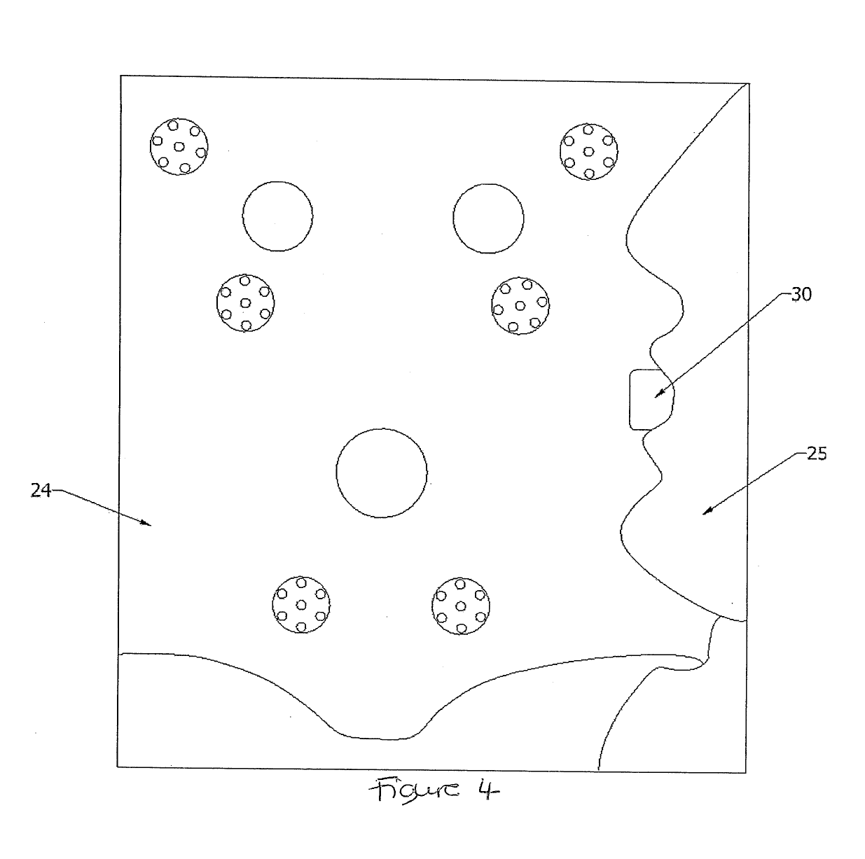

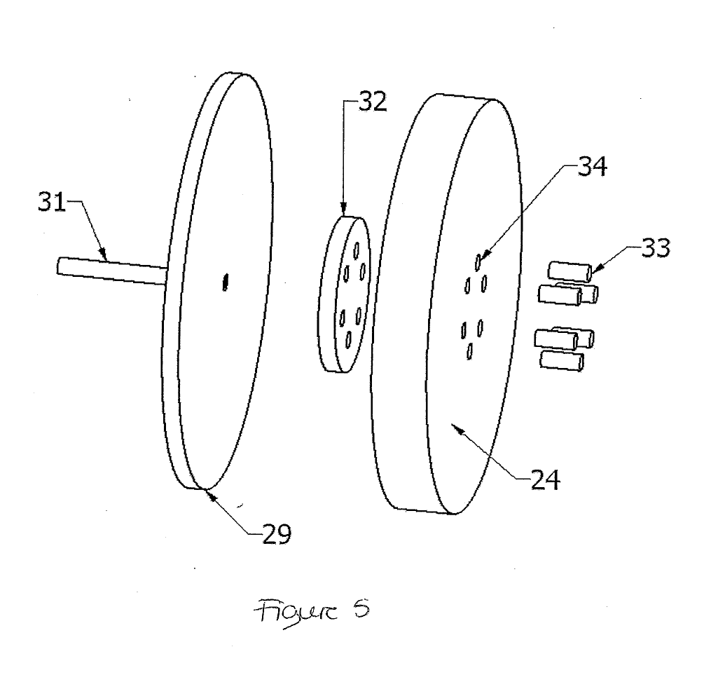

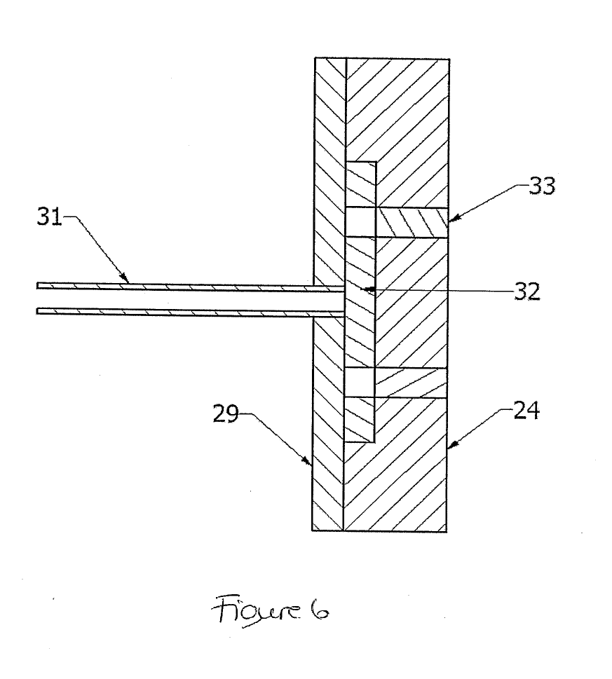

The face 25 and top portion 28 of the head form are then covered in a removable artificial polymer skin 24 as can be seen in FIGS. 3 and 4. The polymer skin 24 is preferably one which mimics human skin. The polymer skin 24 has two functions. The first function of the polymer skin 24 is to provide a realistic seal medium for goggles, respirators and the like to seal against. This enables a seal such as found in real life when testing. The imprint of the skin when goggles, respirators and the like can be measured to determine how much pressure is being put on the human skin of the end goggle or respirator user. The second function of the skin is to provide areas over the perspiration zones 29, to allow the head form to perspire synthetically. Above each of the perspiration zones 29 on the underside of the artificial polymer skin 24 is provided an artificial perspiration reservoir 32 which is preferably formed from a hydrophilic material and is capable of holding artificial perspiration injected into it through the injection pins 31, and capable of releasing the artificial perspiration when heated via the face 25. In order to assist the release of the artificial perspiration when the face 25 is heated the artificial perspiration reservoir is provided with wicks 33 which are in one embodiment integral with the artificial perspiration reservoir 32 and in an alternative embodiment separate from the artificial perspiration reservoir 32. The wicks 33 lead from the artificial perspiration reservoir 32 through perforations 34 in the artificial polymer skin 24 to the surface of the skin 24. In an embodiment the artificial perspiration reservoir 32 is formed from hydrophilic material such as a hydrophilic polymer. In an embodiment the wicks are formed from the same hydrophilic material of the artificial perspiration reservoirs 32 or in the alternative may be formed from an absorbent wicking material. FIGS. 5 and 6 more clearly show the perspiration zones and artificial perspiration reservoirs. The head form 11 is connected to a heater control 16 which enables the head form 11 to be heated to user defined temperatures for user defined periods of time to simulate the heat typically emitted by a human head during given activities in given environments.

The head form 11 is also connected to a series of distribution valves 15, which operate to introduce artificial perspiration to the head form 11 via syringe pumps 17. When the areas of the head form 11 are heated artificial perspiration is injected into one or more perspiration zones 29 through the injection pins 31 as desired to replicate the desired amount of sweating. As the artificial perspiration heats up in the artificial perspiration reservoirs 32, the artificial perspiration moves to the surface of the artificial polymer skin 24 via the wicks 33 and may either sit on the surface of the skin as sweat droplets or evaporate from the surface of the skin in vapour form. Once the desired sweating has taken place the amount of fogging and misting of goggles, respirator or the like placed on the head form 11 during the simulation can be measured. In an embodiment the results are obtained by comparing the pre- and post-simulation data of the test screen chart, in real-time by comparison to pre-simulation calibrated data.

In addition, the head form 11 may be connected to a humidifier system 13 and a breathing machine 14 which operate to simulate the human respiration system in the head form 11 through a mouth cavity 23 provided in the head form 11. This system is particularly important when testing the effect of human respiration on the external surfaces of goggles, respirator or the like when simulating the head being in an enclosed space (i.e. within the chamber), and also particularly important when testing goggles, respirator or the like which cover both the eyes, mouth and nose regions. In these instances not only the moisture from perspiration, but also the moisture from respiration may have an effect on the internal fogging and misting of the goggles, respirator or the like. The humidifier system 13 and breathing machine 14 are designed to simulate human breathing in a number of scenarios where the moisture formed from perspiration may be high or low, slow breathing or rapid breathing and the like.

Analysis of the respirator fogging intensity is generated from periodic examination of the custom designed test chart screen 12. Comparison of real time test chart screen 12 data from the NI vision system 19 are compared to pre-simulation data resulting in visual feedback gauging levels of misting per zone. An indication of the level of misting is given by relating the data to standardised acuity levels of visual impairment. For example the indications could be negligible misting for 20/25 vision or better, light misting for approximately 20/25 vision-20-50 vision, medium misting for approximately 20/50 vision-20/200 vision, heavy misting for worse than 20/200 vision which is the European and American legally blind threshold.

The apparatus is calibrated initially by recording data from an image of the test chart screen 12 using the NI vision system 19 with goggles formed from optician supplied acuity filters which represent the various levels of vision to be compared to i.e. 20/25 vision, 20/25 vision-20-50 vision, 20/50 vision-20/200 vision, and 20/200. The data specifically recorded is the contrast of the squares (i.e. the colour on a greyscale) on the test chart screen 12 and the area of the squares which are visible. The simulation is then run with the goggles or other equipment to be tested and the data collected pre-simulation, during and post-simulation. The same data is collected as with the calibration i.e. the contrast of the squares and the area of the squares which are visible. The control system and software then determines the level of vision by comparing the data collected with the initial acuity filter data. Where the contrast level and area of the squares visible differs (i.e. one being 20/25 vision equivalent and one being 20/50 vision equivalent) the software gives the result of the worst vision. In addition the software automatically discounts squares on the test chart screen which are not in complete view of the NI vision system 19, i.e. obscured by the goggles 40 or other equipment being tested.

The user interface and control system (Head Form Control Program) has been engineered to individually communicate with each hardware component, providing control parameters and receiving data feedback, whilst simultaneously analysing and displaying visual data from NI vision system in the head form 11 at the highest frame rate possible. A highly user-friendly interface has been created for this system allowing the complexity of test options to be varied depending upon the operators preferences. A detailed report of each test sequence is produced on completion, providing details including time stamped sensor feedback and analysed data displaying misting information.

Where a breathing machine is provided it is fabricated from materials to provide high levels of chemical resistance. In one embodiment the breathing machine is fabricated from metals with high levels of chemical resistance. Actuator driven metal bellows provide the lung capacity for the machine; this reduces contamination from seals and provides virtually maintenance free operation. A humidifier is connected in line with the breathing machine to add the option of humidified breath.

The feedback signals from the humidity and temperature probes are serially communicated to the main control program via a microcontroller running a measurement initiate, receive and decode program. This microcontroller is housed in an enclosure secured in the head form torso. A green LED is mounted on the front of the enclosure to indicate that the microcontroller is powered correctly.

The pump and valves are mounted in an enclosure located at the front of the lower shelf of the operator's bench. Four extra valves are mounted internally in the head form torso to direct sweat flow to the scalp. Each of the enclosed valves is mounted above or below an indicator LED. This illuminates when the valve is in operation, providing a visual indication of a satisfactory supply voltage.

The pump is microcontroller driven supplying positional and operational feedback via a serial connection. Control commands are also sent to the pump via this connection.

The perspiration system comprises a plurality of sweat zones that can be utilized in a simulation. During the simulation script creation process the user can select the number and position of sweat zones they wish to be active, resulting in a maximum sweat rate in the system of 120 ml/hour (twenty fully active zones). The user can also reduce the sweat rate of the selected zones and reduce the percentage that each zone sweats. The default sweat rate is 100% per zone, assuming the overall sweat rate is not reduced this will result in a 6 ml/h sweat rate in that zone. If it is desired that some zones sweat less than others the percentage of maximum sweat rate can be reduced for each zone individually.

Each main element of hardware, peripheral to the control system and computer 20, is microcontroller based to minimize the processing time of the data acquisition system and maximize the vision capture and analysis. The control system cyclically monitors sensor and error feedback from each device and outputs updated control parameters when they are needed, other than this the hardware devices are self sufficient, excluding the breathe humidity system which relies on processed sensor feedback in the main control program to maintain the desired humidity levels.

A custom designed, rotating carbon composite arm houses, manages and protects the wiring loom and sweating pipe work from the operating bench to the head form. The arm contains highly effective insulating material and a regulated heater throughout its length to minimize the possibility of any sweat channels freezing. When the operating table is aligned with the chamber and secured with the latches the arm will seat comfortably in the notch in the chamber wall. As well as providing a means of access for the head form into the chamber this notch also provides a means of support during the testing process. The arm is designed to revolve approximately 270 degrees, the extremes of which are the outside wall of the chamber aligned with the operating bench (i.e. the wall with the alignment brackets attached) and when in position in the chamber.

Insulated covers have been fabricated for the carbon composite support arm and the lower section of the head form. These will provide extra protection against potential freezing in the sweating system and shall always be used in tests exploiting environmental temperatures below 6° C.

The chamber 10 can be operated in two different ways. As previously described, when running a head form test the chamber is controlled and monitored serially by the control program. If the chamber 10 is required for use independently to the Head Form System it can be programmed using the touch screen display built into the front of the chamber. Using this display the user may alter the temperature and humidity set points in real time or programmatically.

The breathing machine actuator in this system is managed through an intelligent controller. This allows programs for each breathing profile to be saved to the drive's on-board memory which can then be initiated via serial commands. This system reduces main program processing time, providing faster and more accurate profile responses and enables the breathing profiles to be used with other systems.

What is claimed is:

1. An apparatus for simulating perspiration and respiration comprising:
a) an anthropometric form adapted to simulate at least the head of a human or animal body wherein the anthropometric form is provided with:
i) a mouth cavity connected to a breathing tube adapted to simulate respiration; and
ii) a plurality of artificial perspiration zones adapted to simulate perspiration; and
b) a detection means.

2. An apparatus as claimed in claim 1 wherein the breathing tube is connected to a humidifier.

3. An apparatus as claimed in claim 1 wherein each of the artificial perspiration zones comprises an artificial perspiration reservoir for containing artificial perspiration, and means for facilitating release of the artificial perspiration from the perspiration reservoirs.

4. An apparatus as claimed in claim 3 wherein each of the artificial perspiration reservoirs comprises a hydrophilic membrane.

5. An apparatus as claimed in claim 3 wherein the means for facilitating release of the artificial perspiration from the artificial perspiration reservoir comprises a wick extending from the artificial perspiration reservoir to the atmosphere.

6. An apparatus as claimed in claim 5 wherein the wick is separate to the artificial perspiration reservoir.

7. An apparatus as claimed in claim 5 wherein the wick is integral with the artificial perspiration reservoir.

8. An apparatus as claimed in claim 1 further comprising a synthetic skin adapted to cover all of part of the anthropometric form.

9. An apparatus as claimed in claim 8 wherein the artificial perspiration reservoirs are located between the anthropometric form and the synthetic skin and the wicks extend from the artificial perspiration reservoirs through the synthetic skin to the external surface of the synthetic skin.

10. An apparatus as claimed in claim 8 wherein the artificial perspiration reservoirs are located on the external surface of the synthetic skin.

11. An apparatus as claimed in claim 2 further comprising means for introducing artificial perspiration to the artificial perspiration reservoirs.

12. An apparatus as claimed in claim 11 wherein the means for introducing artificial perspiration to the artificial perspiration reservoirs comprises a series of individually computer-controlled valves.

13. An apparatus as claimed in claim 1 wherein the anthropometric form is heat conductive.

14. An apparatus as claimed in claim 1 wherein the anthropometric form is divided into one or more independently controlled heated areas.

15. An apparatus as claimed in claim 13 which when heated results in artificial perspiration being released from the artificial perspiration reservoirs.

16. An apparatus as claimed in claim 1 further comprising at least one eye socket.

17. An apparatus as claimed in claim 16 wherein the detection means is located in the at least one eye socket.

18. An apparatus as claimed in claim 1 wherein the detection means comprises a camera.

19. An apparatus as claimed in claim 1 wherein the detection means comprises a vision acquisition system.

20. An apparatus as claimed in claim 1 wherein the detection means comprises a temperature sensor.

21. An apparatus as claimed in claim 1 wherein the detection means comprises a humidity sensor.

22. An apparatus as claimed in claim 1 wherein the detection means comprises a moisture sensor.

23. An apparatus as claimed in claim 1 further comprises a climatic chamber in which the anthropometric form is located within.

24. An apparatus as claimed in claim 23 wherein the climatic chamber provides for external control of temperature and humidity.

25. An apparatus as claimed in claim 1 wherein the anthropometric form is provided with goggles or a respirator or other protective head wear.

26. An apparatus as claimed in claim 25 wherein the level of misting or fogging inside the goggles or respirator or other protective head wear resulting from the artificial perspiration or respiration is measured by the detection means.

27. A method of simulating perspiration and respiration comprising the steps of
a) providing an apparatus as claimed in claim 1;
b) causing the artificial perspiration zones to perspire artificially;
c) causing the breathing tube to respire artificially; and
d) measuring the perspiration and respiration created using the detection means.

28. (canceled)

29. (canceled)
